(19) United States
(12) Patent Application Publication
(10) Pub. No.: US 2012/0077174 A1
(43) Pub. Date: Mar. 29, 2012

(54) COMPETENCY ASSESSMENT TOOL

(76) Inventor: William DePaul, Eliot, ME (US)

(21) Appl. No.: 13/226,349

(22) Filed: Sep. 6, 2011

Related U.S. Application Data
(60) Provisional application No. 61/387,530, filed on Sep. 29, 2010.

(51) Int. Cl. G09B 3/00

(52) U.S. Cl. 434/322

(57) ABSTRACT

Core competencies of a participant, such as an employee, is assessed using a competency assessment tool. A developer defines core competencies for any of a variety of topics and develops questions and demonstrative tasks for respective learning objectives under the core competencies. Participants, in turn, perform the demonstrative tasks that are evaluated by an observer and provide responds to the questions. A score is calculated based on the evaluation and response to determine how well the participant exhibits the learning objectives and the competency of the participant is assessed, which is communicated to the participant. A recommendation is made to an administrator to create a development plan when the participant's score falls below a predetermined threshold. In certain embodiments, the participant is a subject matter expert that validates a nexus between the learning objectives and the questions and demonstrative tasks.

### CROSS-REFERENCE TO RELATED APPLICATIONS

This application claims priority to, and the benefit of, U.S. Application Ser. No. 61/387,530, filed on Sep. 29, 2010, titled “A process, Method, or Tool for Validating an Individual's Knowledge or Skill on Any Particular Subject, Topic or Task.”

### FIELD

Embodiments generally relate to assemblies, methods, devices, and systems for assessing competency of a participant, and more particularly, to assemblies, methods, devices, and systems for assessing competency of a participant based on responses of a participant to questions and tasks that were initially validated by subject matter experts.

### BACKGROUND

Achievement of goals of an organization, such as companies, agencies, and universities, often depend on the competency of its workforce. Competency assessment of such individuals is, therefore, vital for progression towards those goals.

Current means (e.g., quizzes, tests, exams, certification programs, etc.) for determining a competency level of an individual are developed to be subject-based and lack the “traceability” back to the core competencies for the subject being measured. Consequently, such systems lack accuracy to pinpoint an individual's weak areas of knowledge or skill.

Accordingly, it would be an advance in the art of management and career development to provide solutions that can help facilitate assessment of an individual's competencies.

### SUMMARY

In certain embodiments, a competency assessment test directed to a selected core competency is formed. The competency assessment test includes a plurality of questions and optionally a plurality of tasks. An expert participant score threshold is set. The competency assessment test is administered to an expert in the core competency to obtain an actual expert participant score. If the expert participant score is greater than the expert participant score threshold, the competency assessment test is validated. If the expert participant score is equal to or less than the expert participant score threshold, the competency assessment test is administered to a second expert to obtain a second actual expert participant score. If the second expert participant score is equal to or less than the expert participant score threshold, the competency assessment test is not validated.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates an exemplary embodiment of Applicant's system for competency assessment;

FIG. 2 is a schematic showing exemplary modules encoded in computer readable mediums within the system of FIG. 1;

FIGS. 3A-10B are each a screen shot of a user interface corresponding to the exemplary modules of FIG. 2; and

FIG. 11 summarize a method and/or process related to the system of FIG. 1.

### DETAILED DESCRIPTION

The invention is described in preferred embodiments in the following description with reference to the FIGs., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “in certain embodiments,” and similar language throughout this specification may, but do not necessarily, all refer to the same embodiment. It is noted that, as used in this description, the singular forms “a,” “an” and “the” include plural referents unless the context clearly dictates otherwise.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In certain embodiments, core competencies of a participant (e.g., employee, a potential employee, a contractor, or agent) is assessed using an assessment tool, such as the administration of a competency assessment test. A developer provides parameters for a competency assessment tool. The parameters include core competencies for any of a variety of topics, corresponding knowledge or skill sets required for the respective core competencies, corresponding learning objectives for the respective knowledge or skill sets, and corresponding questions and demonstrative tasks for the respective learning objectives. The parameters are stored in a data repository, such as a relational database, in association with the identified respective core competencies.

Participants provide electronic responds to the questions via a user interface. Participants optionally also perform one or more demonstrative tasks that are evaluated by an observer who electronically provides the respective evaluations via a corresponding user interface. A score is calculated based on the responses and evaluations to determine how well the participant exhibits the learning objectives and the competency of the participant is assessed, which, in turn, is communicated to the participant. A recommendation is made to an administrator to create a development plan when the score of the participant falls below a predetermined threshold having a development plan threshold value. In certain embodiments, the participant is a subject matter expert (“expert participant”) in which case the score is used to validate a nexus between the questions and/or demonstrative tasks and the corresponding learning objective.

Consequently, in certain embodiments, the competency assessment test is used to evaluate the core competencies of participants and the corresponding deficiencies of the participant are identified in a manner that is traceable back to the identified core competencies in a standardized process with parameters that were validated by subject matter experts.

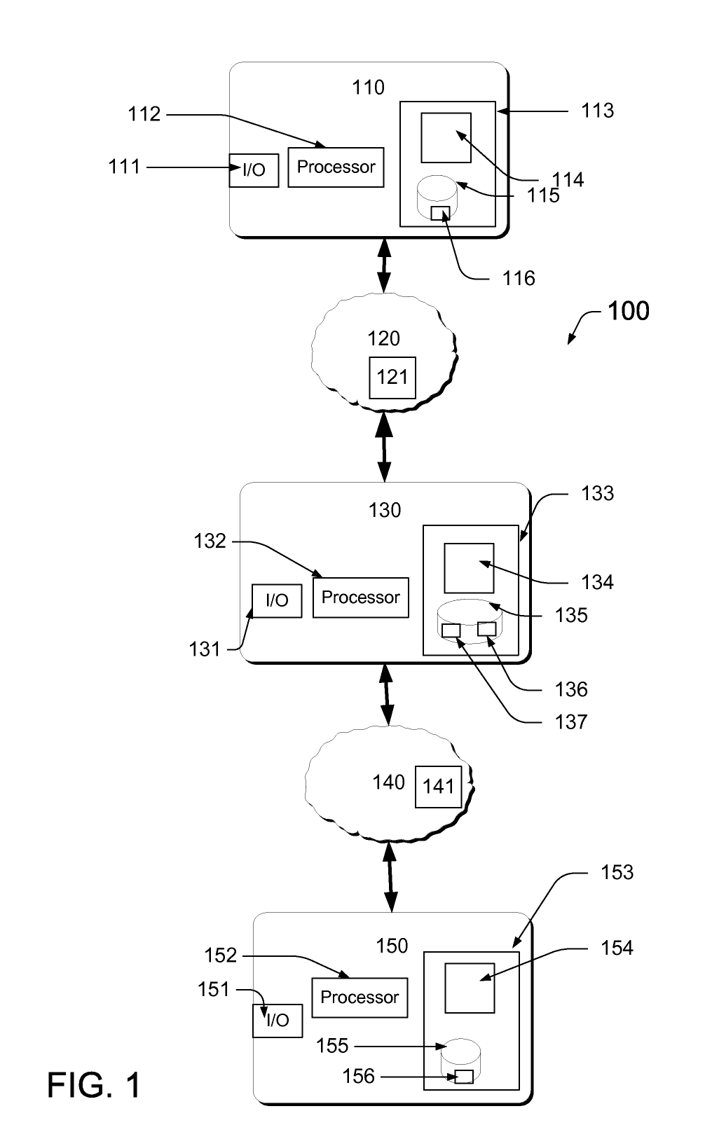

Referring to FIG. 1, a system 100 for data management is illustrated. In the illustrated embodiment of FIG. 1, system 100 comprises a computing device 130 that is communicatively connected to a computing device 110 through a first communication fabric 120 and a computing device 150 through a second communication fabric 140. In certain embodiments, the computing device 130 is a computing device that is owned and/or operated by a host; the computing device 110 is a computing device that is owned and/or operated by a participant; and the computing device 150 is computing device that is owned and/or operated by a developer and/or an administrator and/or an observer of demonstrative tasks. In other embodiments, each of the developer, the administrator, and the observer have corresponding respective computing devices 150 or computing devices 110.

In certain embodiments, the computing device 130 is also the computing devices 110 and 150. Here, a single computing device 130 is owned and/or operated by each of the host, the participant, the developer, the administrator, and the observer and the communication fabrics 120 and 140 are not utilized.

For the sake of clarity, FIG. 1 shows a single computing device 110, computing device 130, and computing device 150. FIG. 1 should not be taken as limiting. Rather, in other embodiments any number of entities and corresponding devices can be part of the system 100, and further, although FIG. 1 shows two communication fabrics 120 and 140, in other embodiments less or more than two communication fabrics is provided in the system 100. For example, in certain embodiments, the communication fabric 120 and the communication fabric 140 are the same communication fabric.

In certain embodiments, the computing devices 110, 130, and 150 are each an article of manufacture. Examples of the article of manufacture include: a server, a mainframe computer, a mobile telephone, a personal digital assistant, a personal computer, a laptop, a set-top box, an MP3 player, an email enabled device, a tablet computer, or a web enabled device having one or more processors (e.g., a Central Processing Unit, a Graphical Processing Unit, programmable processor, and/or a microprocessor) that is configured to execute an algorithm (e.g., a computer readable program or software) to receive data, transmit data, store data, or performing methods or other special purpose computer, for example.

By way of illustration and not limitation, FIG. 1 illustrates the computing device 110, the computing device 130, and the computing device 150 as each including: a processor (112, 132, and 152, respectively); a non-transitory computer readable medium (113, 133, and 153, respectively) having a series of instructions, such as computer readable program steps encoded therein; an input/output means (111, 131, and 151, respectively) such as a keyboard, a mouse, a stylus, touch screen, a camera, a scanner, or a printer. The non-transitory computer readable mediums 113, 133, and 153 each include corresponding computer readable program codes (114, 134, and 154, respectively) and data repositories (115, 135, and 155, respectively). The processors 112, 132, and 152 access corresponding computer readable program codes (114, 134, and 154, respectively), encoded on the corresponding non-transitory computer readable mediums (113, 133, and 153, respectively), and executes one or more corresponding instructions (116, 136, and 156, respectively).

In one example, the processors 112 and 152 access corresponding Application Program Interfaces (APIs) encoded on the corresponding non-transitory computer readable mediums (113 and 153, respectively), and executes instructions (e.g., 116 and 156, for example respectively) to electronically communicate with the computing device 130. Similarly, the processor 132 accesses the computer readable program code 134, encoded on the non-transitory computer readable medium 133, and executes an instruction 136 to electronically communicate with the computing device 110 via the communication fabric 120 or electronically communicate with the computing device 150 via the communication fabric 140. A log 137 is maintained of the data communicated or information about the data communicated (e.g., date and time of transmission, frequency of transmission . . . etc.) with any or all of the computing device 110 and the computing device 150. In certain embodiments, the log 137 is analyzed and/or mined.

In certain embodiments, the data repositories 115, 135, and 155 each comprises one or more hard disk drives, tape cartridge libraries, optical disks, combinations thereof, and/or any suitable data storage medium, storing one or more databases, or the components thereof, in a single location or in multiple locations, or as an array such as a Direct Access Storage Device (DASD), redundant array of independent disks (RAID), virtualization device, . . . etc. In certain embodiments, one or more of the data repositories 115, 135, and 155 is structured by a database model, such as a relational model, a hierarchical model, a network model, an entity-relationship model, an object-oriented model, or a combination thereof. For example, in certain embodiments, the data repository 135 is structured in a relational model and stores a plurality of questions or instructions for demonstrative task as attributes in a matrix for an identified core competency.

In certain embodiments, the computing devices 110, 130, and 150 include wired and/or wireless communication devices which employ various communication protocols including near field (e.g., “Blue Tooth”) and/or far field communication capabilities (e.g., satellite communication or communication to cell sites of a cellular network) that support any number of services such as: Short Message Service (SMS) for text messaging, Multimedia Messaging Service (MMS) for transfer of photographs and videos, electronic mail (email) access, or Global Positioning System (GPS) service, for example. In certain embodiments, the computing device 110, 130, and 150 employ hardware and/or software that supports accelerometers, gyroscopes, solid state compasses and the like.

As illustrated in FIG. 1, the communication fabrics 120 and 140 each comprise one or more switches 121 and 141, respectively. In certain embodiments, at least one of the communication fabrics 120 and 140 comprises the Internet, an intranet, an extranet, a storage area network (SAN), a wide area network (WAN), a local area network (LAN), a virtual private network, a satellite communications network an interactive television network, or any combination of the foregoing. In certain embodiments, at least one of the communication fabrics 120 and 140 contains either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabrics 120 and 140 utilize any of a variety of communication protocols, such as Transmission Control Protocol/Internet Protocol (TCP/IP), for example.

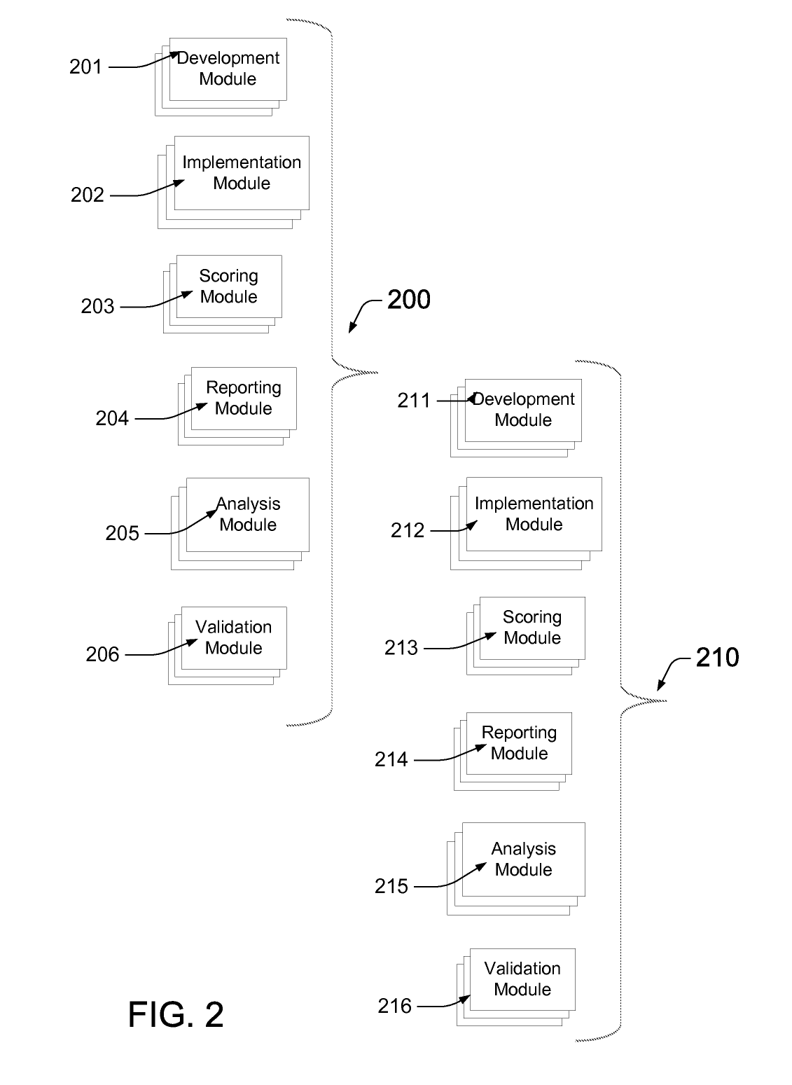

Referring to FIGS. 1 and 2, in some embodiments, at least one or more portions of the system 100 can be implemented as a software and/or hardware module that can be locally and/or remotely executed on one or more of the computing devices 110, 130, and 150. For example, one or more portions of the system 100 can include a hardware-based module (e.g., a digital signal processor (DSP), a field programmable gate array (FPGA)) and/or a software-based module (e.g., a module of computer code or a set of processor-readable instructions that can be executed at a processor).

By way of example and not limitation, various modules are illustrated in FIG. 2. Here, module assembly 200 and/or 210 are locally and/or remotely executable on one or more computing devices 110, 130, and/or 150 in a serial and/or parallel fashion to implement a competency assessment tool within the system 100 to, for example, develop and/or validate and/or administer a competency assessment test.

Many of the functional units described in this specification have been labeled as modules (e.g., modules 201, 202, 203, 204, 205, 206, 211, 212, 213, 214, 215, and 216, FIG. 2) in order to more particularly emphasize their implementation independence. For example, a module (e.g., modules 201, 202, 203, 204, 205, 206, 211, 212, 213, 214, 215, and 216, FIG. 2) may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules (e.g., modules 201, 202, 203, 204, 205, 206, 211, 212, 213, 214, 215, and 216, FIG. 2) may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically collocated, but may comprise disparate instructions stored in different locations which, when joined logically together, comprise the module and achieve the stated purpose for the module.

Indeed, a module of executable code (e.g., modules 201, 202, 203, 204, 205, 206, 211, 212, 213, 214, 215, and 216, FIG. 2) may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

### Development Module

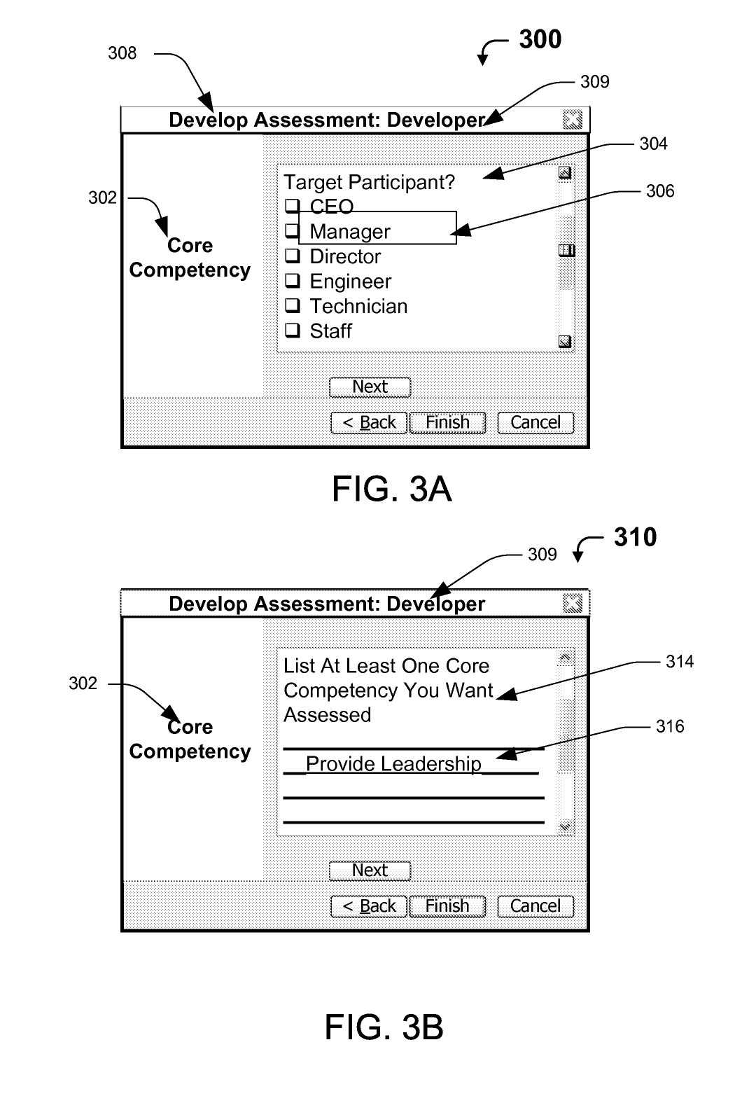

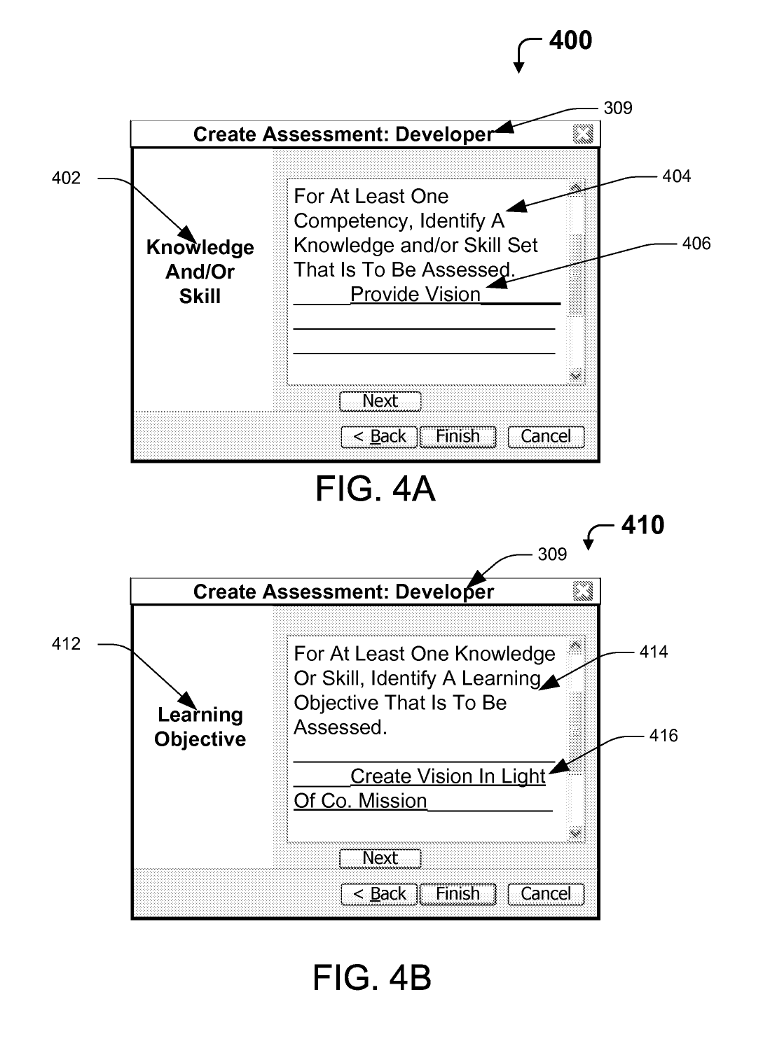

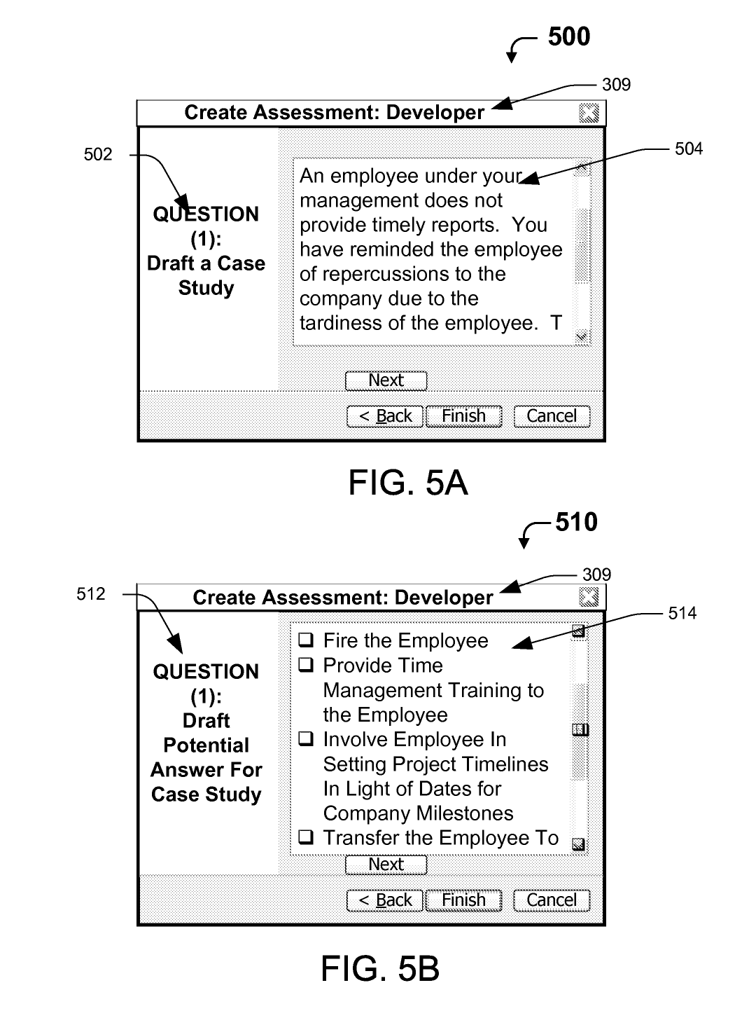

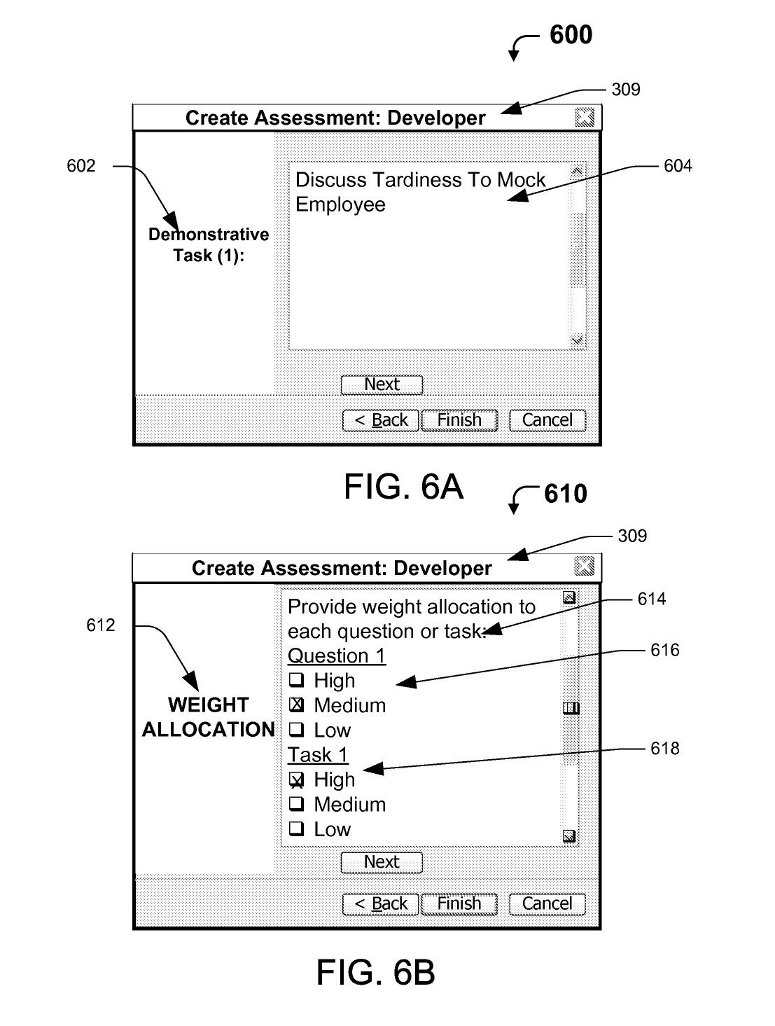

Referring to FIGS. 1, 2 and 3A-6B, in certain embodiments, a processor (e.g., processor 152) executes the development module 201 to develop parameters for the competency assessment tool. For example, the development module 201 is executable on the computing device 150 to render the user interfaces 300, 310, 400, 410, 500, 510, 600, and 610 in which queries are posed to a developer 309. The developer 309, in turn, provides, via the respective user interfaces, data that become parameters for the competency assessment tool. Here, the developer 309 is queried to identify at least one core competency 302 (FIG. 3A); at least one knowledge or skill 402 (FIG. 4A) for each core competency; at least one learning objective 412 (FIG. 4B) for each knowledge or skill; corresponding questions 502 (FIG. 5A) for each of the learning objectives 412; corresponding potential answers 514 (FIG. 5B); and corresponding instructions for demonstrative tasks 602 (FIG. 6A) for each of the learning objectives 412. For example, for each learning objective, the developer 309, drafts questions (e.g., Question 504), a plurality of corresponding answers (e.g., potential answers 514) for each question, and instructions for demonstrative tasks 604 that will be evaluated by an observer. The developer 309 then provides 614 weight allocations 612 to the questions and tasks (FIG. 6B). Weight allocations are then used in calculating a score for the responses of the participant and/or evaluation of the observer.

To illustrate, in FIG. 3A, the user interface 300 queries the developer 309 to identify a target participant 304. Here, the developer has selected a manager 306 as a parameter for the target or test participant. The user interface 310 queries the developer 309 to list at least one core competency of the manager that the developer 309 wants to assess 314. The developer 309, in FIG. 3B, has identified “provide leadership” 316 as a core competency that a manager should be able to exhibit. In FIG. 4A, the user interface 400 queries the developer 309 to identify, for at least one identified competency, a knowledge and/or skill set that is to be assessed 404. Here, the developer 309, has identified “provide vision” 406 as a knowledge and/or skill that a manager should be able to exhibit as part of the manager's competency of “provid[ing] leadership.” Other knowledge and/or skills include (not shown): “think ahead,” “take ownership,” “manage change,” “focus on the customer,” or “achieve results,” for example.

The user interface 410, in turn, queries the developer 309 to identify, for at least one identified knowledge and/or skill set, a learning objective that is to be assessed 414. Here, the developer 309, has identified the learning objective as “Create vision in light of Company Mission” 416. In other words, a manager should be able to create a clear vision and mission for ones area of responsibility congruent with and in support of the larger organization's vision and strategy. The developer 309 then drafts a case study 504 (FIG. 5A) and a plurality of corresponding answers 514 (FIG. 5B) for the learning objective “Create vision in light of Company Mission” 416. In this example, the developer 309 also identifies instructions for a demonstrative task. In FIG. 6A, the demonstrative task is for the participant to discuss tardiness to a mock employee 604, which is to be observed by an observer.

The developer 309 then provides weight allocations to the questions and tasks and/or groups of questions and tasks, such as by weighing questions or tasks for a first learning objective higher than those of a second learning objective. In FIG. 6B, the developer 309 has indicated that a correct response to Question (1) has a medium 616 amount of importance while a correct response to the demonstrative task (1) has a high 618 amount of importance. In another embodiment, the weight allocation is at the learning objective level. For example, the developer identifies correct responses to the “Create vision in light of Company Mission” 416 objective as of being high value.

For illustrative purposes, below are exemplary parameters for core competency/knowledge and skill set/learning objective/questions and demonstrative task for assessing a senior manager's competency:

I. CORE COMPETENCY: Provide Leadership
A. Knowledge and/or Skill set: Provide vision
   Learning Objective: A manager should be able to create a clear vision and mission for one's area of responsibility congruent with and in support of the larger organization's vision and strategy.
   Learning Objective: A manager should be able to describe the importance of his/her employees and how their actions are critical in achieving key results.

Question
The view that employees are crucial to organizational success is now generally accepted. Does this mean that
   A) all employees have the same value or potential for the organization?
   B) it reflects the unprecedented success of HR practitioners to deliver?
   C) good management of people will prevail?
   D) managing the human resource has become even more important because it is the one resource most difficult to replicate?

Question
The psychological contract refers to the obligations that an employer and employee perceive to exist between each other as part of the employment relationship. As such it will include:
   A) the loyalty and trust of employees
   B) pay and working conditions
   C) managers pay only “lip service” to consultation
   D) manager reneges on commitments to employees
   Learning Objective: A manager should be able to explain how to keep direct reports focused on achieving the longer-term vision in the face of distracting short-term priorities.
   Learning Objective: A manager should be able to define the steps necessary in communicating the vision and strategic objectives in simple terms that can be understood by all and acted upon.
B. Knowledge and/or Skill set: Think ahead
   Learning Objective: A manager should be able to describe how he/she looks ahead for opportunities and challenges before he/she begin to impact the business.
   Learning Objective: A manager should be able to explain how he/she anticipates future customer and marketplace trends, competitors' positions, and how the company can compete.
   Learning Objective: A manager should be able to identify the broader or long range business implications of current trends or emerging situations.
   Learning Objective: A manager should be able to recognize the reactions and concerns of others which will allow him/her to plan accordingly.
C. Knowledge and/or Skill set: Take ownership
   Learning Objective: A manager should be able to define how he/she will take responsibility to make sure plan goals are achieved.

Question:
Why is it often difficult to prove that the person responsible for an act or omission is a relevant senior manager?
   A) they have too much power
   B) often they have friends in high places
   C) there is often a complex organization structure with responsibility spread among many people
   D) more able to play and lower manages
   Learning Objective: A manager should be able to identify ways to maximize one's group contribution to accompany goals and objectives.
   Learning Objective: A manager should be able to act decisively on issues or challenges one judges to be critical.

Question:
There is a degree of choice in the way in which job cuts are implemented, where making the right choice can minimize consequences of job losses, preserve the reputation of the employer and maintain good employee relations. Who would be responsible for making such decisions?
   A) line managers
   B) senior management
   C) HR specialists
   D) Personnel
Why is it important to ensure that HR plans are flexible?
   A) to accommodate changes to senior management teams
   B) to adapt to changing skills and qualifications
   C) to accommodate the rapidly changing environments in which most organizations operate
   D) to ensure an in depth labor force is maintained at all times
“Vitality” is a method of measuring:
   A) the balance of internal promotions versus external recruitment or loss of employees
   B) training and development costs
   C) retention of skilled staff
   D) level of apprenticeships
   Learning Objective: A manager should be able to recognize a calculated risk where opportunities for success outweigh the cost of failure or delay.
   Learning Objective: A manager should be able to explain his/her thought process for his/her business decisions.
D. Knowledge and/or Skill set: Manage change
   Learning Objective: A manager should be able to list ways to enhance systems operations or products to meet customer needs or preferences.
   Learning Objective: A manager should be able to recognize new ideas to current practices to achieve dramatic improvements/results.

Question
Post-modernistic ideas have impacted our understanding of the role of the rationality in workplaces by recognizing:
   A) one type of rationality prevails
   B) more than one type of rationality prevails in work organizations
   C) the management type of rationality is the only true one to exist at work
   D) employees must learn to respect management's version of rationality at work

Question
A philosophy of management . . . .
   A) doesn't exist
   B) is the assumption managers make about people
   C) is more than a single ingredient
   D) is a style of management

Question
Treating employees as people or as economic resources is:
   A) a choice all managers have to make
   B) mutually exclusive
   C) a question of balance which will be decided by the context of each organization
   D) a matter of luck
   Learning Objective: A manager should be able to explain the communication process to energize and get commitment and support for strategic initiatives.
   Learning Objective: A manager should be able to recognize what aspects of change are causing stress for employees.
   Learning Objective: A manager should be able to describe ways in which they can assist and support employees through a change process.
   Learning Objective: A manager should be able to demonstrate their ability to react positively and constructively to change.
   Learning Objective: A manager should be able to evaluate a situation and make the necessary adjustments to attain a stated goal.
E. Knowledge and/or Skill set: Focus on the customer
   Learning Objective: A manager should be able to create or apply opportunities to interact directly with customers to learn about their future needs.
   Learning Objective: A manager should be able to apply the needs of the customer to drive decisions and strategic choices.
   Learning Objective: A manager should be able to illustrate that the team thinks and works together cross functionally in order to meet customer expectations.
   Learning Objective: A manager should be able to act on customers' concerns whether they stem from reality or perception.
   Learning Objective: A manager should be able to demonstrate his/her communication with customers to determine if one's product and services are meeting the needs and problems are resolved.
F. Knowledge and/or Skill set: Achieve results
   Learning Objective: A manager should be able to show that he/she has set challenging yet realistic stretch goals for themselves and others to out-perform expectations.
   Learning Objective: A manager should be able to select milestones and measure outcomes to ensure goals are met.
   Learning Objective: A manager should be able to schedule time and resources on deliverables rather than activities.
   Learning Objective: A manager should be able to explain how he/she has balanced resources to enable efficient accomplishment of both near and long-term objectives.
   Learning Objective: A manager should be able to list ways to leverage existing resources to maximize profit.
   Learning Objective: A manager should be able to demonstrate that he/she has provided resources, removed obstacles and assisted others so they can meet commitments and deadlines.
   Learning Objective: A manager should be able to show that he/she has acknowledged employees for the achievement of desired results and rewarded them for surpassing expectations.

II. CORE COMPETENCY: Address Complex Business Challenges
A. Knowledge and/or Skill set: Seek and Validate Information
   Learning Objective: A manager should be able to state targeted questions that drill down into details in order to make appropriate decisions.
   Learning Objective: A manager should be able to identify who to contact to get needed answers in a timely manner.
   Learning Objective: A manager should be able to demonstrate that he/she can ask tough questions to test the logic of others positions.
   Learning Objective: A manager should be able to list how that he/she has stays informed through casual interactions with a broad range of people at all levels. (i.e.; keeps finger on the pulse, manages by walking around, etc.)
   Learning Objective: A manager should be able to explain how he/she gathers facts and viewpoints from the parties involved in a problem before coming to a conclusion.
B. Knowledge and/or Skill set: Take an Analytical Approach
   Learning Objective: A manager should be able to demonstrate how he/she subdivides large complex projects or issues into manageable components or sequenced elements.
   Learning Objective: A manager should be able to identify the root-cause underlying visible or surface symptoms in a complex situation.
C. Knowledge and/or Skill set: Solve Problems Creatively
   Learning Objective: A manager should be able to explain how he/she has applied learning from prior experience to new situations or in novel ways.
   Learning Objective: A manager should be able to list nontraditional ways to solve difficult problems.
   Learning Objective: A manager should be able to describe ways that he/she has created solutions that simultaneously solved multiple challenges.
D. Knowledge and/or Skill set: Exercise Business Judgment
   Learning Objective: A manager should be able to state how he/she has exercised autonomy and latitude to make their own business judgments.
   Learning Objective: A manager should be able to list accounts when he/she has made time sensitive decisions when full information was lacking.

III. CORE COMPETENCY: Work Effectively with Others
A. Knowledge and/or Skill set: Consider Other Viewpoints
   Learning Objective: A manager should be able to explain how and when to push an issue or change with a particular audience.
   Learning Objective: A manager should be able to identify the unique issues/concerns of key stakeholders.
   Learning Objective: A manager should be able to state how he/she seeks other people's perspectives when making decisions.
B. Knowledge and/or Skill set: Collaborate
   Learning Objective: A manager should be able to explain how he/she maintains ongoing contact with other functions and teams in order to understand their needs and focuses.
   Learning Objective: A manager should be able to state how he/she has listened to alternatives considered and incorporates new ideas which can improve on analysis or decision.
   Learning Objective: A manager should be able to show who to involve to optimize follow-through.
C. Knowledge and/or Skill set: Influence Others' Decisions
   Learning Objective: A manager should be able to summarize how he/she has provided facts and data so that others arrive at a desirable conclusion or point of view on their own.
   Learning Objective: A manager should be able to demonstrate how he/she presents quantitative data or conclusions with credibility by translating them into quantitative implications.
D. Knowledge and/or Skill set: Communicate Clearly
   Learning Objective: A manager should be able to restate organizational, functional, and team goals into terms which describe what individuals must achieve.
   Learning Objective: A manager should be able to demonstrate how he/she informs others of issues, likely questions, or information that may help them achieve results or reach decisions.
   Learning Objective: A manager should be able to listen to other ideas in addition to advocating for all one's own.
E. Knowledge and/or Skill set: Take a Forthright Approach
   Learning Objective: A manager should be able to identify issues or recognize when a difficult issue exists.
   Learning Objective: A manager should be able to explain how he/she raises difficult business and organizational issues that need to be addressed even when others are reluctant to address them.
   Learning Objective: A manager should be able to demonstrate how he/she is candid and constructive in telling others what they may not want to hear
F. Knowledge and/or Skill set: Develop Others
   Learning Objective: A manager should be able to show how he/she identifies specific employees with the idea of creating a balanced team that can work effectively together to meet specific goals.
   Learning Objective: A manager should be able to recall how he/she has matched the person to the job based on his/her interest, potential to excel, and the needs of the organization.
   Learning Objective: A manager should be able to identify times that he/she has given people latitude to perform independently and prove themselves.
   Learning Objective: A manager should be able to provide constructive and timely training in an effort to improve performance.

Question
Structured learning refers to learning that is:
   A) imposed from above
   B) planned and associated with specific outcomes
   C) theoretical in nature
   D) textbook learning
What factors can have a lasting impairment on a person's motivation to learn?
   A) learning for work
   B) learning which is challenging
   C) learning which is instrumental
   D) a negative experience of learning in childhood
Training is more likely to be seen as a cost by those organizations employing what type of worker?
   A) those employed in high-tech companies
   B) those working in motor industries
   C) those employing low skilled workers
   D) those employing high skilled employees
G. Knowledge and/or Skill set: Establish Credibility
   Learning Objective: A manager should be able to demonstrate how he/she projects a professional image on behalf of the company.
   Learning Objective: A manager should be able to state clearly and unambiguously one's thoughts and motives.

In another example, the competency assessment tool is used to access a competency of a “nurse.” Here, a core competency is an ability to start an intravenous line for administering a pharmaceutical treatment, for example. The knowledge or skill, includes knowledge of anatomy and physiology. The learning objective is the ability to: find a vein, apply a venous tourniquet, prepare a needle and line, advance the needle, penetrate the vein on a first attempt, and withdrawing blood without introducing air into the blood stream, for example. The questions, in turn, include multiple choice queries testing anatomy, and procedure of advancing a line into a vein. The demonstrative task is to start an intravenous line.

In yet another example, if the participant is identified as a “technician,” then a core competency is an ability to respond to computer technical problems. Here, the knowledge or skill, includes knowledge of an Operating Systems. The learning objective is the ability to: identify computer viruses, install programs, and train others on software usage. The questions, in turn, include multiple choice queries testing Operating System commands and ability to utilize computer diagnostics, for example.

Referring back to FIG. 2, in certain embodiments, the developing assessment module 211 is executable on the computing device 130 to receive the parameters of the developer and store them in the data repository 135, such as in a relational model database in association with a particular competency assessment, such as assessment for “managers” 306.

### Implementation Module

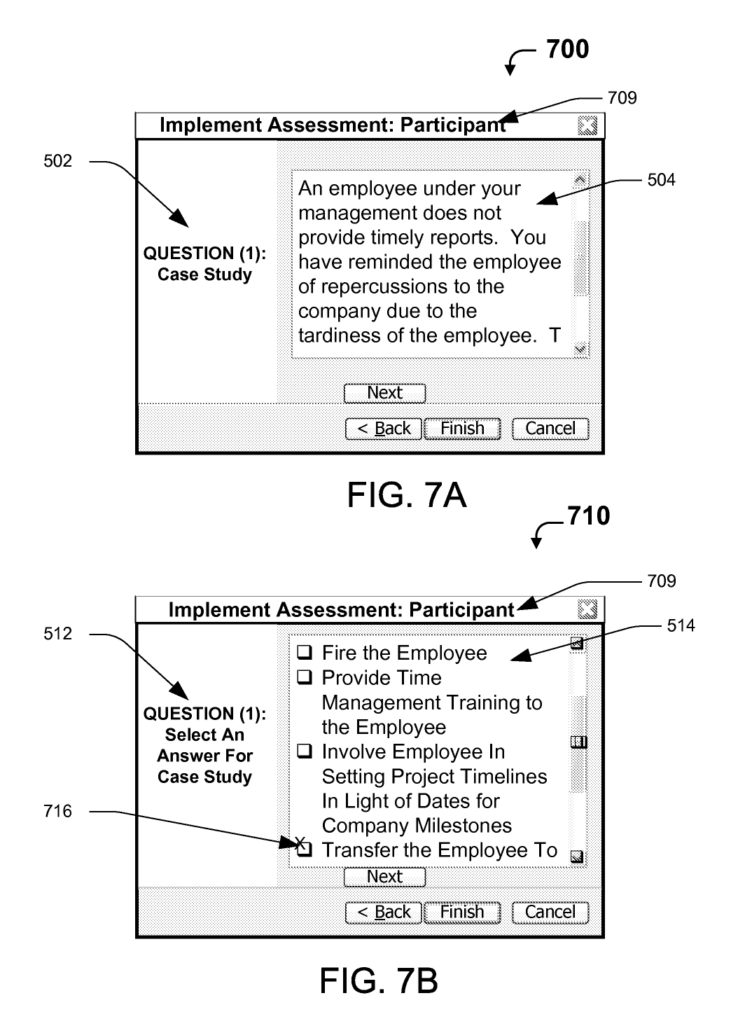

In certain embodiments, a processor (e.g., processor 112) executes the implementation module 202 to receive responses of a test participant to the predetermined questions of the developer. For example, the implementing assessment module 202 is executed to render the user interfaces 700 and 710 of FIGS. 7A, and 7B respectively, in which queries are posed to a participant 709. Here, the case study 504 question 502 that was created by the developer 309 is rendered on the computing device 110 of the participant 709. At user interface 710, the participant is give a plurality of answers 514 to select from. In this example, the participant has selected answer 716 as a response of the participant.

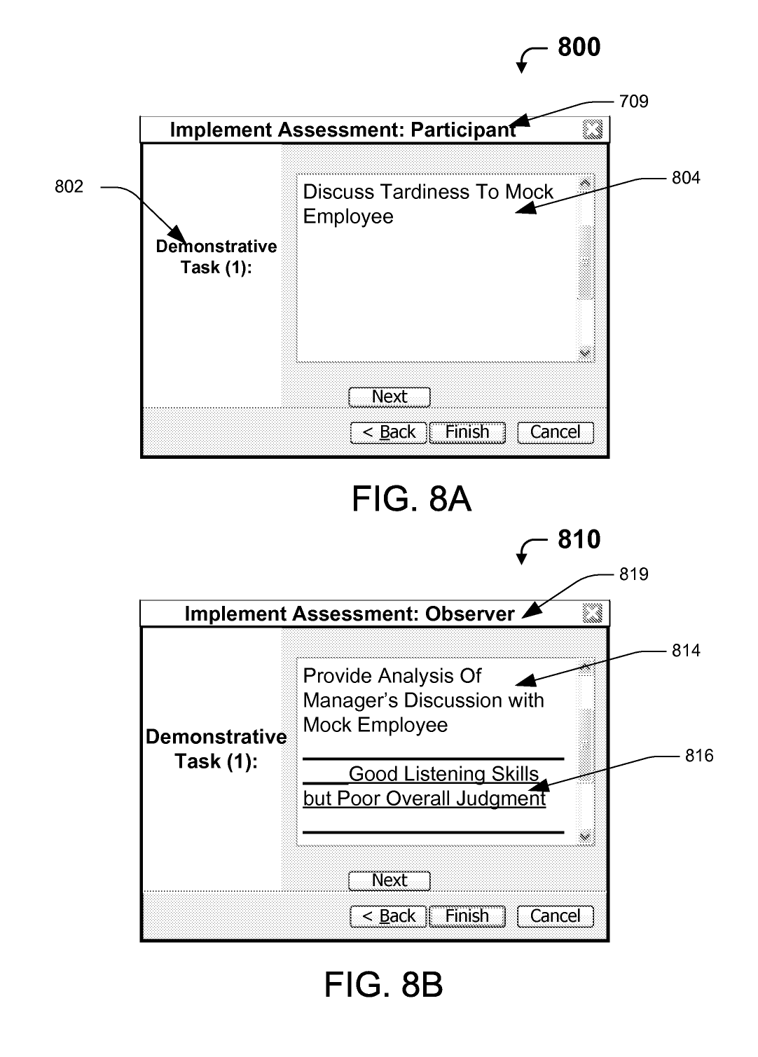

Referring to FIGS. 2 and 8A-8B, in certain embodiments, a processor (e.g., processor 112 or 152) executes the implementation module 202 to obtain an evaluation of an observer when the participant 709 performs the predetermined demonstrative tasks of the developer 309. For example, the implementation module 202 is executed to render the user interfaces 800 and 810 of FIGS. 8A, and 8B, respectively, in which instructions for a demonstrative task is rendered to the participant 709 and observer 819, respectively. For example, the demonstrative task 802 that was created by the developer 309 is rendered on the computing device 110 of the participant as “discuss tardiness to a mock employee.” At user interface 810, the observer is give an opportunity to provide a textual evaluation 814 of the performance of the participant 709 in the task of “discuss[ing] tardiness to a mock employee” 804. In this example, the observer 819 has provided the evaluation 816 that the participant 709 has “good listening skills but poor overall judgment.” In another embodiment, the evaluation of the observer is numerical. For example, the observer 819 evaluates the performance of the demonstrative task as follows: 5 points awarded if the participant 709 completes the task without asking questions, or having difficulty completing the task within an allotted time period; 2 points are awarded if the participant 709 had some difficulty performing the task but did not need time beyond the allotted time period; and 0 points awarded when the participant 709 did not complete the task, asked many questions or had great difficulty performing the task in the allotted time period.

Referring back to FIG. 2, in certain embodiments, a processor of system 100 (e.g., processor 132) executes the implementation module 212 to receive the responses of the participant 709 and the evaluation of the observer 819 and store each in the data repository (e.g., data repository 135), such as in a relational model database in association with the participant 709. The responses of the participant 709 is then scored (“actual test participant score”) and a competency assessment is then conducted.

### Scoring Module

Referring to FIGS. 1 and 2, in certain embodiments, a processor of system 100 (e.g., processor 112) executes the scoring module 203 and/or a processor (e.g., processor 132) executes the scoring module 213 to calculate a score based on the responses of the participant 709 and/or the evaluation of the observer 819 when the participant performed the predetermined demonstrative tasks of the developer 309.

For illustrative purposes only, the examples below provide scenarios and corresponding score calculations when the scoring modules 203 and/or 213 is executed:

### Scenario for Calculation of Responses to Questions:

all questions are multiple-choice with only one correct answer
all questions will be weighted as either (H) high value, (M) median value, or (L) low value
there is no specified total number of (H), (M), or (L) questions that will be asked on any particular assessment, nor any fixed ratio between (H), (M), or (L) questions
all (H) value questions will be awarded four points
all (M) value questions will be awarded two points
all (L) value questions will be awarded one point
the end result assessment average (grade) will only reflect a score that is proportional to the number of questions that were asked from each of the (H), (M), or (L) groups
therefore, the table below represents the total points awarded for each correct answer from the three (H), (M), and (L) type questions

| | (H) | (M) | (L) |
|---|---|---|---|
| Points | 4 | 2 | 1 |
| awarded for | | | |
| correct | | | |
| selection | | | |

Example #1: If the number of questions on the assessment totals 100, and:
(H)—4—40%—40 questions=160 points
(M)—2—40%—40 questions=80 points
(L)—1—20%—20 questions=20 points

Total Points Available=260

Then the weighted % of each of the (H) (M), and (L) is the following:

### (H)—61% (160/260)

### (M)—31% (80/260)

### (L)—8% (20/260)

And suppose the following number of answers were correct:
(H)—30 correct out of 40=75%
(M)—35 correct out of 40=87.5%
(L)—20 correct out of 20=100%
Then multiply each % correct by the weighted % and add the results for a total test score:

### (H)—75%*61%=45.75%

### (M)—87.5%*31%=27.125%

### (L)—100%*8%=8%

Total Score of Test=80.875%

Example #2: Another situation with the number of questions totaling 75, and:
(H)—4—50.66%—38 questions=152 points
(M)—2—16%—12 questions=24 points
(L)—1—33.33%—25 questions=25 points

Total Points Available=201

Then the weighted % of each of the (H) (M), and (L) is the following:

### (H)—75.6% (152/201)

### (M)—11.9% (24/201)

### (L)—12.4% (25/201)

And suppose the following number of answers were correct:
(H)—32 correct out of 38=84.2%
(M)—12 correct out of 12=100%
(L)—20 correct out of 25=80%
Then multiply each % correct by the weighted % and add the results for a total test score:

### (H)—84.2%*75%=63.65%

### (M)—100%*11.9%=11.9%

### (L)—80%*12.4%=9.92%

Total Score of Test=85.47%

### Scenario for Calculation of Evaluations of Demonstrative Tasks:

all questions are multiple-choice and all having three selections for answers (A), (B), or (C)
all questions will be weighted as either (H) high value, (M) median value, or (L) low value
there is no specified total number of (H), (M), or (L) questions that will be asked on any particular assessment, nor any fixed ratio between (H), (M), or (L) questions
all (H) value questions will be awarded four points
all (M) value questions will be awarded two points
all (L) value questions will be awarded one point
selection (A) will be awarded a five points
selection (B) will be awarded two points
selection (C) will be awarded zero points
the total assessment average (grade) will only reflect a score that is proportional to the number of questions that were asked from each of the (H), (M), or (L) groups
therefore, the table below represents the total points awarded for each possible combination, i.e. (H) question with a selection of (A) would equal 20 points, an (M) question with a selection of (B) would equal 4 points, etc

| Selection | (H) | (M) | (L) |
|---|---|---|---|
| (A) | 4 × 5 = 20 | 2 × 5 = 10 | 1 × 5 = 5 |
| (B) | 4 × 2 = 8 | 2 × 4 = 4 | 1 × 2 = 2 |
| (C) | 4 × 0 = 0 | 2 × 0 = 0 | 1 × 0 = 0 |

Example #1: If the number of questions on the assessment totals 100:
(H)—40%—40 questions×20=800 points
(M)—40%—40 questions×10=400 points
(L)—20%—20 questions×5=100 points

Total Points Available=1300

And questions were answered with the following selections
(H) (A)—20=400 points
(H) (B)—15=120 points
(H) (C)—5=0 points

Total of (H) points=520

(M) (A)—30=300 points
(M) (B)—5=20 points
(M) (C)—5=0 points

Total of (M) points=320

(L) (A)—18=90 points
(L) (B)—2=4 points
(L) (C)—0=0 points

Total of (L) points=94

Then the total number of points percent for each (H) (M) or (L) is the following:

### (H)—65% (520/800)

### (M)—80% (320/400)

### (L)—94% (94/100)

The total percent of questions in each category for (H) (M) or (L) is the following:

### (H)—(40/100)=40%

### (M)—(40/100)=40%

### (L)—(20/100)=20%

Then multiply the total number of points % by the total % of questions in each category for (H) (M) and (L) and add the results for a total test score:

### (H)—65%*40%=28.86%

### (M)—80%*40%=32%

### (L)—94%*20%=18.8%

Total Score of Test=79.66 correct

Example #2: Another situation with the number of questions totaling 24, and:
(H)—54.1%—13 questions×20=260 points
(M)—37.5%—9 questions×10=90 points
(L)—8.33%—2 questions×5=10 points

Total Points Available=360

And the questions were answered with the following selections:
(H) (A)—8=160 points
(H) (B)—4=32 points
(H) (C)—1=0 points

Total of (H) points=192

(M) (A)—6=60 points
(M) (B)—3=12 points
(M) (C)—0=0 points

Total of (M) points=72

(L) (A)—2=10 points
(L) (B)—0=0 points
(L) (C)—0=0 points

Total of (L) points=10

Then the total number of points percent for each (H) (M) and (L) is the following:

### (H)—61.5% (160/260)

### (M)—78.2% (72/90)

### (L)—1% (10/10)

The total percent of questions in each category for (H) (M) and (L) is the following:

### (H)—(13/24)=54.1%

### (M)—(9/24)=37.5%

### (L)—(2/24)=8.33%

Then multiply the total number of points % by the total % of questions in each category for (H) (M) and (L) and add the results for a total test score:

### (H)—61.5%*54.1%=32.27%

### (M)—78.2%*37.5%=29.32%

### (L)—1%*8.33%=8.33%

Total Score of Test=69.92% correct

### Reporting Module

Referring back to FIG. 2, in certain embodiments, a processor (e.g., processor 112 and/or 132) executes the reporting module 204 and/or the reporting module 214, respectively to create a report based on the score of the participant. Here, the score is used to determine a deficiency in the corresponding competency, corresponding knowledge or skill set, or learning objective. In some embodiments, a score that is below a predetermined threshold is considered a deficiency. For example, if the participant's responses and performance of demonstrative tasks for the “provid[ing] vision” knowledge and skill set are above a certificate award threshold value but lower than the one for the “thinking ahead” knowledge and skill set certificate award threshold value, then the report identifies “thinking ahead” skills as a deficiency of the participant.

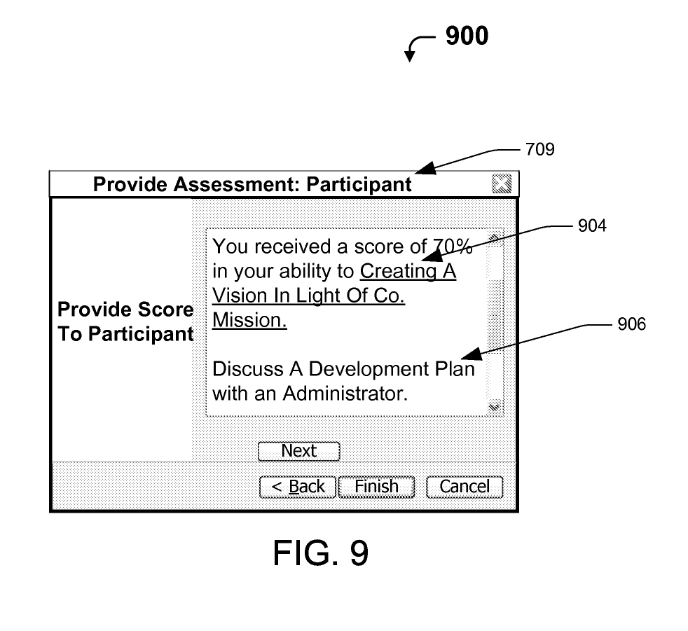

Referring to FIGS. 2 and 9, in certain embodiments, a processor (e.g., processor 112) executes the reporting module 204 to create a report based on the score of the participant, which is rendered via user interface 900 on the computing device 110 to a participant, for example. In FIG. 9, the user interface 900 indicates to the participant 709 that she scored 70% in her ability to meet the learning objective of “creating a vision in light of company's mission.” Here, 70% is below a development plan threshold value (e.g., 80%, not shown) consequently, the participant is advised to “discuss a development plan with an administrator” 906.

### Analysis Module

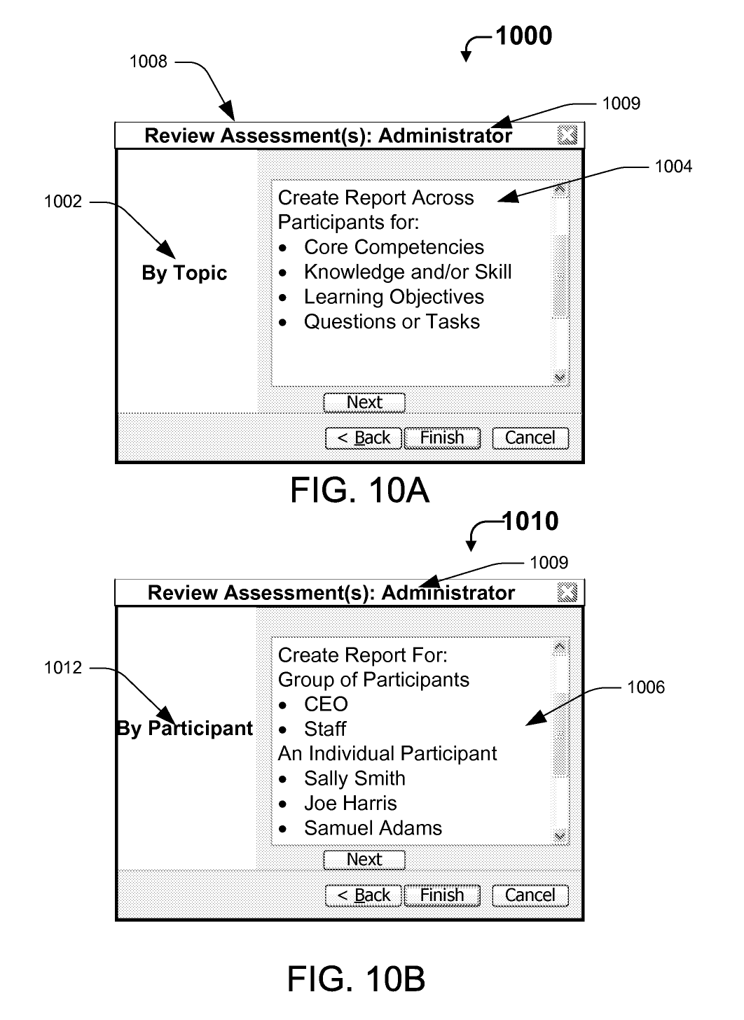

Referring to FIGS. 2 and 10A-10B, in certain embodiments, a processor (e.g., processor 132) executes the analysis module 214 to create a report based on a score of the participant(s) and peers of participant(s) for rendition on a computing device (e.g., 130), for example. In FIG. 10, the user interface 1000 provides an administrator 1009 an option to create reports by topic 1002 across participants. Similarly, the user interface 1010 provides the administrator an option to create reports by participants 1012, such as groups of participants or individuals. Here, the administrator 1009 creates reports based on the scores of participants. If the report of an individual participant 709 shows a deficiency in an identified learning objective or core competency, for example, the administrator 1009 uses the data in the report to create a development plan for the participant 709 so that the deficiency can be alleviated. In some embodiments, the administrator 1009 is the developer 309 that developed the parameters for the competency assessment tool.

In come embodiments, after the development plan is implemented, the participant retakes the questions and re-performs the demonstrative tasks to obtain a second score. Here, the efficacy of the development plan is evaluated. If the second score is not significantly better than the first, the development plan is refined.

### Validation Module

Referring back to FIGS. 2, in certain embodiments, a processor (e.g., processor 132) executes the validation module 216 to validate a nexus between the questions and demonstrative tasks and corresponding learning objectives and/or knowledge and skill sets and/or core competencies. Here, the participant 709, for example, is a subject matter expert, such as an expert in the core competency, who is expected to achieve a high score by providing correct responses to substantially all the questions propounded. If a plurality of subject matter experts do not provide a sufficient number of correct responses to the questions and/or demonstrative tasks (e.g., an actual expert participant score of the expert is above an expert participant score threshold value), then the nexus between the questions and demonstrative tasks and corresponding learning objectives and/or knowledge and skill sets and/or core competencies is considered weak. If the nexus is considered weak, the competency assessment test is not validated and the developer 309 provides other parameters to the competency assessment tool (via, for example, user interfaces 300, 310, 400, 410, 500, 510, 600, and 610).

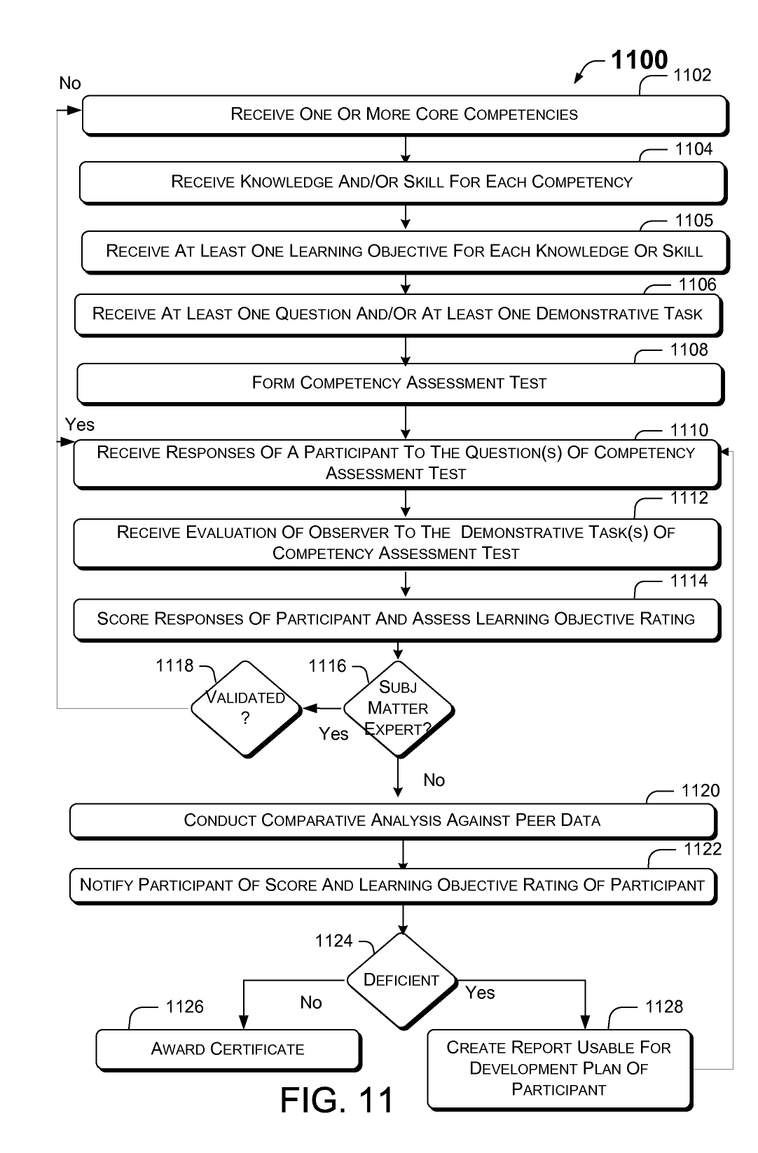

In FIG. 11, a flow chart summarizes an exemplary method 1100 for assessing a competency of a participant. At step 1102, one or more core competencies are received. For example, a developer identifies or selects one or more core competencies and uses the computing device 150 to send the identified or selected one or more core competencies to the computing device 130 operated by the host. At step 1104, knowledge and/or skill sets are received for each of the competencies identified in step 1102. For example, the developer 309 generates one or more knowledge and/or skill sets and sends them to the computing device 130 via the user interface 400. At step 1105, at least one learning objective is received for each of the knowledge/skills sets identified in step 1104. For example, the developer 309 creates one or more learning objective and sends them to the computing device 130 via the user interface 410. At step 1106, at least one learning question and/or demonstrative task is received for each of the learning objectives identified in step 1105. In certain embodiments the demonstrative tasks are optional. At step 1108, a competency assessment test is formed. The participant, in turn, uses the computing device 110 to take the competency assessment test, such as by receiving the questions and being instructed on the demonstrative tasks. At step 1110, the responses of the participant to the questions is received and at step 1112 the evaluation of an observer of the participant's performance of the demonstrative task is received. At step 1114, the responses and evaluation of steps 1110 and 1112, respectively, is scored and/or the learning objective rating assessed. Here, the score is used to assess the ability of the participant to meet the learning objective.

At step 1116, if the participant is a subject matter expert, the method 1100 moves from step 1114 to step 1118. At step 1118 the questions and demonstrative tasks received in step 1106 are validated. For example, if the score of the subject matter expert is below an expert participant score threshold value (e.g., 70% correct) then a conclusion is made that the questions and/or demonstrative tasks do not have a close nexus to the corresponding: learning objectives; and/or knowledge or skill set; and/or core competency. If a close nexus does not exist, then the questions and/or demonstrative tasks are not validated, in which case the method 1100 moves from step 1118 back to step 1102 and the parameters are refined. Alternatively, if a close nexus does exist (e.g., the score of the subject matter expert is above a predetermined threshold), then the method 1100 moves from step 1118 back to step 1110 where a second participant, that is different from first subject matter expert (e.g., a second participant or second subject matter expert), responds to the questions (step 1110) and/or demonstrative tasks (step 1112) which are scored (step 1114) to obtain an actual test participant score.

At step 1116, if the participant is not a subject matter expert, the method 1100 moves from step 1114 to step 1120. At step 1120 a comparative analysis is conducted in which the score of the participant is compared with scores of peers of the participant that responded to the same questions and performed the same demonstrative tasks as the participant.

At step 1122, the participant is notified of the score of the participant and the assessment of the participant's learning objective rating of step 1114. At step 1124, a determination is made as to whether there is a deficient in at least one of learning objectives, knowledge or skill set, and core competency. For example, if the score of the participant is equal to or greater than a certificate award threshold (e.g., actual test participant score of 800 is above a certificate award threshold of 750 points), then method 1100 moves from step 1124 to step 1126 in which a certificate is awarded to the participant, such as providing the participant a certificate award. Alternatively, if the score of the participant is less than the certificate award threshold (e.g., score 700 is below the certificate award threshold of 750 points), then method 1100 moves from step 1124 to step 1128 in which a report usable to develop a development plan of the participant is created and/or generated. The report is, in turn, used to create and/or generate a development plan, by the administrator, the developer, or the subject matter expert, for example. In certain embodiments the report and or the development plan is reviewed with the participant that took the competency assessment test. In certain embodiments, after the development plan is implemented, the participant voluntarily repeats and/or is required to repeat the method 1100, such as from step 1110.

In certain embodiments, method 1100 has a step 1125 (not shown) at which a determination is made whether the actual test participant score is above or equal to a development plan threshold value. If the score of the participant is below the development plan threshold value, then the method moves from step 1125 to step 1128. Alternatively, if the score of the participant is above the development plan threshold value, method 1100 terminates. In certain embodiments, if the score of the participant is above the development plan threshold value, a test report is generated that has a plurality of requirements. The administrator or developer or expert then reviews the test report with the participant that took the competency assessment test.

In certain embodiments, the development plan threshold value is set to be equal to the certificate award threshold value (e.g., both are 750 points). In other embodiments, the development plan threshold value is set to be different from the certificate award threshold value (e.g., the first being 800 points while the latter being 750 points). For example, a participant receives a score of 775 points for the competency assessment test which has a certificate award threshold value of 800 points and a development plan threshold value of 750. Here, the participant will not be awarded a certificate at step 1126 and a report usable for the development plan will not be created (step 1128) because the score of 775 of the participant is above the development plan threshold value of 750 but below the certificate threshold value of 800 points. In certain embodiments, when the score of the participant is less than the certificate award threshold value but greater than the development plan threshold value, a test report is generated for the participant's review. The participant is then required to retake the competency assessment test at a later time.

In certain embodiments, the validation of the competency assessment test is maintained when an actual job performance rating earned by a set of participants matches their corresponding scores. For example, a recurring evaluation time interval is set (e.g., every 12 weeks). A set of participants are selected, such as “n” participants. At the expiration of the recurring evaluation time interval: (A) a listing (e.g., in descending order) is prepared of the most recent actual job performance rating earned by each of the (n) participants who were more recently administered the competency assessment test; and (B) a listing (e.g., in descending order) is prepared of the score obtained by each of the (n) participants who were more recently administered the competency assessment test. When the list of the most recent actual job performance ratings matches the list of scores, the validation of the competency assessment test is maintained. For example, if 10 participants had high scores on the competency assessment test and the same 10 participants received excellent actual job performance ratings, then the validation of the competency assessment test is maintained. Alternatively, if the high scoring participants received poor actual job performance ratings then the validation is not maintained. In certain embodiments, if the validation is not maintained, the method 1100 is repeated. For example, in one embodiment, another expert takes the competency assessment test, repeating method 1100 from step 1110. Here, if the score of the expert is greater than an expert participant score threshold (e.g., 800 points), the validation of the competency assessment test is maintained.

In a certain embodiment, a competency assessment test is formed, tested, and administered to participants. Here, the competency assessment test that is directed to a selected core competency is formed (e.g., step 1108). The competency assessment test includes a plurality of questions and requires performance of a plurality of demonstrative tasks, such as performance of a plurality of tasks. An expert participant score threshold is set, such as setting a “800 points” as a threshold score that is expected from a participant that is a subject matter expert. The competency assessment test is given to a first expert to obtain an actual expert participant score (e.g., “850 points”), which is the score of the first expert upon taking the competency assessment test (e.g., step 1116). If the actual expert participant score is greater than or equal to the expert participant score threshold (e.g., 850 points>800 points), then the competency assessment test is validated (e.g., step 1118). On the other hand, if the actual expert participant score is equal to or less than the expert participant score threshold, then the competency assessment test is administered to a second expert to obtain a second actual expert participant score of the second expert. If the second actual expert participant score is equal to or less than the expert participant score threshold, then the competency assessment test is not validated (e.g., step 1118).

The schematic flow chart diagrams included are generally set forth as a logical flow-chart diagram (e.g., FIG. 11). As such, the depicted order and labeled steps are indicative of one embodiment of the presented method. In certain embodiments, other steps and methods are conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types are employed in the flow-chart diagrams, they are understood not to limit the scope of the corresponding method (e.g., FIG. 11). Indeed, some arrows or other connectors may be used to indicate only the logical flow of the method. For instance, an arrow indicates a waiting or monitoring period of unspecified duration between enumerated steps of the depicted method. Additionally, the order in which a particular method occurs may or may not strictly adhere to the order of the corresponding steps shown.

In certain embodiments, individual steps recited in FIG. 11 are combined, eliminated, or reordered. In certain embodiments, the computer readable program code described reside in any other computer program product, where that computer readable program code is executed by a computer external to, or internal to, system 100 (FIG. 1), to perform one or more of steps recited in FIG. 11. In either case, in certain embodiments, the computer readable program code is encoded in a non-transitory computer readable medium comprising, for example, a magnetic information storage medium, an optical information storage medium, an electronic information storage medium, and the like. “Electronic storage media,” means, for example and without limitation, one or more devices, such as and without limitation, a PROM, EPROM, EEPROM, Flash PROM, compactflash, smartmedia, and the like.

Examples of computer readable program code include, but are not limited to, micro-code or micro-instructions, machine instructions, such as produced by a compiler, code used to produce a web service, and files containing higher-level instructions that are executed by a computer using an interpreter. For example, embodiments are be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, multiple, distributed qualification processing systems can be configured to operate in parallel.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

I claim:

1. A method to assess a competency of a participant, comprising:
forming a competency assessment test directed to a selected core competency, and comprising a plurality of questions and, optionally, requiring performance of a plurality of tasks;
setting an expert participant score threshold;
administering the competency assessment test to a first expert in the core competency to obtain a first actual expert participant score;
if the first actual expert participant score is greater than the expert participant score threshold, validating the competency assessment test;
if the first actual expert participant score is equal to or less than the expert participant score threshold, administering the competency assessment test to a second expert in the core competency to obtain a second actual expert participant score; and
if the second actual expert participant score is equal to or less than the expert participant score threshold, not validating the competency assessment test.

2. The method of claim 1, wherein the forming further comprises:
identifying one or more core competencies;
generating one or more knowledge areas and/or one or more skill sets for each core competency;
creating one or more learning objectives for each knowledge area;
drafting at least one question for each learning objective;
creating one or more said tasks for each skill set; and
including a plurality of the questions in the competency assessment test.

3. The method of claim 2, further comprising allocating a weight value to each of the questions included in the competency assessment test.

4. The method of claim 2, further comprising including a plurality of the tasks in the competency assessment test.

5. The method of claim 4, further comprising allocating a weight value to each of the tasks included in the competency assessment test.

6. The method of claim 1, further comprising:
setting a certificate award threshold value;
setting a development plan threshold value;
administering the competency assessment test to a first test participant to obtain a first actual test participant score; and
if the first actual test participant score is greater than or equal to the certificate award threshold value, providing to the first test participant a certificate award.

7. The method of claim 6, further comprising, if the first actual test participant score is less than the certificate award threshold value but greater than the development plan threshold value:
generating a test report for the first test participant;
reviewing the test report with the first test participant, the development plan including a plurality of requirements; and
requiring that the first test participant retake the competency assessment test at a later time.

8. The method of claim 7, further comprising, if the first actual test participant score is less than or equal to the development plan threshold value:
generating a development plan for the first test participant;
reviewing the development plan with the first test participant; and
requiring that the first test participant retake the competency assessment test after completing all of the requirements set forth in the development plan.

9. The method of claim 6, further comprising:
setting a recurring evaluation time interval;
setting a value for (n); and
at the expiration of the recurring evaluation time interval:
preparing a first listing reciting a most recent actual job performance rating earned by each of the (n) test participants who were more recently administered the competency assessment test;
preparing a second listing reciting a corresponding said actual test participant obtained by each of the (n) test participant who were more recently administered the competency assessment test; and
if the first listing matches the second listing, maintaining the validation of the competency assessment test.

10. The method of claim 9, further comprising:
if the first listing and the second listing do not match, administering the competency assessment test to a third expert to obtain a third actual expert participant score; and
if the third actual expert participant score is greater than the expert participant score threshold, maintaining the validation of the competency assessment test.

11. A computer program product encoded in a non-transitory computer readable medium, the computer program product being useable with a computing device comprising a programmable processor to assess a competency of a participant, the computer program product comprising:
computer readable program code which causes the programmable processor to form a competency assessment test directed to a selected core competency, and comprising a plurality of questions and, optionally, requiring performance of a plurality of tasks;
computer readable program code which causes the programmable processor to set an expert participant score threshold;
computer readable program code which causes the programmable processor to administer the competency assessment test to a first expert in the core competency to obtain a first actual expert participant score;
computer readable program code which causes the programmable processor to validate the competency assessment test if the first actual expert participant score is greater than the expert participant score threshold;
computer readable program code which causes the programmable processor to, if the first actual expert participant score is equal to or less than the expert participant score threshold, administer the competency assessment test to a second expert in the core competency to obtain a second actual expert participant score; and
computer readable program code which causes the programmable processor to not validate the competency assessment test if the second actual expert participant score is equal to or less than the expert participant score threshold.

12. The computer program product of claim 11, wherein the computer readable program code which causes the programmable processor to form the competency assessment test further comprises:
computer readable program code which causes the programmable computer processor to identify one or more core competencies;
computer readable program code which causes the programmable computer processor to generate one or more knowledge areas and/or one or more skill sets for each core competency;
computer readable program code which causes the programmable computer processor to create one or more learning objectives for each knowledge area;
computer readable program code which causes the programmable computer processor to draft at least one question for each learning objective;
computer readable program code which causes the programmable computer processor to create one or more said tasks for each skill set; and
computer readable program code which causes the programmable computer processor to include a plurality of the questions in the competency assessment test.

13. The computer program product of claim 12, further comprising computer readable program code which causes the programmable computer processor to allocate a weight value to each of the questions included in the competency assessment test.

14. The computer program product of claim 12, further comprising computer readable program code which causes the programmable computer processor to include a plurality of the tasks in the competency assessment test.

15. The computer program product of claim 14, further comprising computer readable program code which causes the programmable computer processor to allocate a weight value to each of the tasks included in the competency assessment test.

16. An article of manufacture comprising a processor and a non-transitory computer readable medium having computer readable program code disposed therein to assess a competency of a participant, the computer readable program code comprising a series of computer readable program steps to effect:
forming a competency assessment test directed to a selected core competency, and comprising a plurality of questions;
setting an expert participant score threshold;
administering the competency assessment test to a first expert in the core competency to obtain a first actual expert participant score;
if the first actual expert participant score is greater than the expert participant score threshold, validating the competency assessment test;
if the first actual expert participant score is equal to or less than the expert participant score threshold, administering the competency assessment test to a second expert in the core competency to obtain a second actual expert participant score; and
if the second actual expert participant score is equal to or less than the expert participant score threshold, not validating the competency assessment test.

17. The article of manufacture of claim 16, wherein the computer readable program code further comprises a series of computer readable program steps to further effect:
setting a certificate award threshold value;
administering the competency assessment test to a first test participant to obtain a first actual test participant score; and
if the first actual test participant score is greater than or equal to the certificate award threshold value, providing a certificate award to the first test participant.

18. The article of manufacture of claim 17, wherein the computer readable program code further comprises a series of computer readable program steps to further effect:
setting a development plan threshold value;
and
if the first actual test participant score is less than the certificate award threshold value but greater than the development plan threshold value:
generating a test report for the first test participant;
reviewing the test report with the first test participant, the development plan including a plurality of requirements; and
requiring that the first test participant retake the competency assessment test at a later time.

19. The article of manufacture of claim 16, wherein the computer readable program code further comprises a series of computer readable program steps to further effect:
administering the competency assessment test to a plurality of test participants to obtain corresponding actual test participant scores;
setting a recurring evaluation time interval;
setting a value for (n); and
at the expiration of the recurring evaluation time interval:
preparing a first listing reciting a most recent actual job performance rating earned by each of (n) test participants who were more recently administered the competency assessment test;
preparing a second listing reciting a corresponding actual test participant obtained by each of the (n) test participant who were more recently administered the competency assessment test; and
if the first listing matches the second listing, maintaining the validation of the competency assessment test.

20. The article of manufacture of claim 19, wherein the computer readable program code further comprises a series of computer readable program steps to further effect:
if the first listing and the second listing do not match, administering the competency assessment test to a third expert to obtain a third actual expert participant score; and
if the third actual expert participant score is greater than the expert participant score threshold, maintaining the validation of the competency assessment test.
